(19) United States
(12) Patent Application Publication
(10) Pub. No.: US 2015/0289553 A1
(43) Pub. Date: Oct. 15, 2015

(54) METHOD OF DEVELOPING SAFE AND EFFECTIVE DIETARY SUPPLEMENTS

(71) Applicant: Carsten R. Smidt, Sandy, UT (US)

(72) Inventor: Carsten R. Smidt, Sandy, UT (US)

(21) Appl. No.: 14/250,299

(22) Filed: Apr. 10, 2014

(51) Int. Cl. A23L 1/302; A23L 1/304

(52) U.S. Cl. CPC A23L 1/302; A23L 1/304; A23V 2002/00

(57) ABSTRACT

Disclosed is a method of formulating a dietary supplement in which a formulator utilizes one or more of the safety limit amount, the clinical efficacy range and the Paleolithic intake amount range for an ingredient in the dietary supplement to determine a common range, and then subtracts from the common range the un-supplemented intake of the ingredient of the target consumer to determine the safe and effective range for the dietary supplement which the formulator may incorporate into a dietary supplement.

### FIELD

The present disclosure is in the field of formulating dietary supplements.

### BACKGROUND

When formulating a dietary supplement, a major concern is determining safe and effective dosages for each ingredient in the supplement. Currently, common practice is to: (i) to consult published Upper Limits (ULs) or No Observed Adverse Effect Levels (NOAELs) to establish safe ingredient levels, and (ii) to review the published scientific literature to find dosages that have been shown safe and/or effective in humans or animals. Unfortunately, these steps are not enough. Applying merely such a method to formulating a dietary supplement may still result in a lack of efficacy and the occurrence of unexpected long-term safety problems.

A number of large, well-designed clinical and epidemiological studies have failed to show benefits of dietary supplements and some have found safety issues of nutrient dosages that were once considered safe. For example, starting in the 1990s experts started recommending calcium supplementation using daily doses as high as 1,500 mg. Recently, however, the National Institutes of Health-AARP diet and health study found that high intake of supplemental calcium is associated with an excess risk of cardiovascular disease death in men. (Xiao Q, et al., Dietary and supplemental calcium intake and cardiovascular disease mortality: the National Institutes of Health-AARP diet and health study, JAMA Internal Medicine. Apr. 22 2013; 173(8):639-646). The European Prospective Investigation into Cancer and Nutrition study with almost 24,000 participants showed that calcium supplements raised the risk of myocardial infarction. (Li K, et al., Associations of dietary calcium intake and calcium supplementation with myocardial infarction and stroke risk and overall cardiovascular mortality in the Heidelberg cohort of the European Prospective Investigation into Cancer and Nutrition study (EPIC-Heidelberg), Heart, June 2012; 98(12):920-925). Likewise, high-dose vitamin E supplementation (400-2,000 IU/d) became popular in the 1990s due to encouraging results of epidemiological and small intervention studies. Since 2005, however, several larger intervention studies showed negative results. For example, in 2005 the Women's Health Study showed that 600 IU vitamin E taken every other day had no effects on cardiovascular health or cancer prevention in 39,876 women (Lee I M, Cook N R, Gaziano J M, et al. Vitamin E in the primary prevention of cardiovascular disease and cancer: the Women's Health Study: a randomized controlled trial. JAMA 2005; 294(1):56-65.). Also in 2005, a meta-analysis of 19 trials with 135,967 subjects showed that 400 IU/d vitamin E increased mortality (Miller E R, 3rd, Pastor-Barriuso R, Dalal D, Riemersma R A, Appel L J, Guallar E. Meta-analysis: high-dosage vitamin E supplementation may increase all-cause mortality. Annals of Internal Medicine. 2005; 142(1):37-46.). In 2008, the Physicians Health Study showed that 400 IU vitamin E taken every other day for 8 years did not reduce the risk for cardiovascular disease in 14,641 men (Sesso H D, Buring J E, Christen W G, et al. Vitamins E and C in the prevention of cardiovascular disease in men: the Physicians' Health Study II randomized controlled trial. JAMA: 2008; 300(18):2123-2133.). Finally the SELECT study showed in 2011 that a 400 IU vitamin E supplement taken for 7-12 years increased the risk of prostate cancer in 35,533 men (Klein E A, Thompson I M, Jr., Tangen C M, et al. Vitamin E and the risk of prostate cancer: the Selenium and Vitamin E Cancer Prevention Trial (SELECT), JAMA: 2011; 306(14):1549-1556). Another study in JAMA found that taking a daily multivitamin for 11 years did not reduce major cardiovascular events or mortality (Sesso, et al., Multivitamins in the prevention of cardiovascular disease in men: the Physicians' Health Study II randomized controlled trial, JAMA: 2012; 308(17):1751-1760). There are dozens of more examples where supplementation with doses of micronutrients once thought to be safe turned out to be either ineffective or detrimental to health. These include folic acid (cancer), beta-carotene (cancer), iodine (thyroid cancer, hypothyroidism), chromium (DNA damage), and antioxidant combinations such as vitamins C and E (blunt positive effects of exercise). A recent Cochrane systematic review also questioned the efficacy of high-dose vitamin D suuplementation (Bjelakovic G, Gluud L L, Nikolova D, et al. Vitamin D supplementation for prevention of mortality in adults. Cochrane database of systematic reviews. 2014; 1:CD007470.).

The core problem with the supplements used in these studies and virtually all products on the market is that they rely only on published safety and efficacy data available at the time of formulation, which typically is incomplete. Thus, conventional methods of formulating dietary supplements can result in end products that may be potentially unsafe, especially when used long-term.

### SUMMARY

The present disclosure describes and enables a systematic process for formulating dietary supplements that results in safer and hence more effective dietary supplements. The disclosed process forces a dietary supplement developer to not only consider all known safety and efficacy data, but also applies additional safeguards to predict safety and efficacy and provides as a result a safer and hence more effective dietary supplement. This is achieved by considering not only published safety and efficacy data, but also by using datasets of estimated Paleolithic nutrient intakes, and nutrient intakes from food by the target consumer group. When practiced as described herein, the disclosed method prevents the use of dietary supplement ingredient types and dosages that the human body has not been exposed to throughout human evolution. The method described in this disclosure also accounts for nutrient intakes from food by the target consumer to avoid potentially unsafe additive effects of supplementation and diet. Finally, the method described in this disclosure may be computer-assisted to ensure a systematic approach, which is especially useful in formulating multi-component dietary supplements, such as multivitamin/mineral formulations.

Although not required, the disclosed process may be implemented with a data processing device via computer program instructions executed by one or more computing devices that can take the form of a traditional server/desktop/laptop; mobile device such as a smartphone or tablet; etc. Computing devices typically include one or more processors coupled to data storage for computer program modules and data. Key technologies include, but are not limited to, the multi-industry standards of Microsoft and Linux/Unix based Operating Systems; databases such as SQL Server, Oracle, NOSQL, and DB2; Business Analytic/Intelligence tools such as SPSS, Cognos, SAS, etc.; development tools such as Java, .NET Framework (VB.NET, ASP.NET, AJAX.NET, etc.); and other e-Commerce products, computer languages, and development tools. Such program modules generally include computer program instructions such as routines, programs, objects, components, etc., for execution by the one or more processors to perform particular tasks, utilize data, data structures, and/or implement particular abstract data types. The disclosed acts and operations described hereinafter may also be implemented in hardware.

The foregoing and other objects, features, and advantages of this disclosure will become more apparent from the following detailed description, which proceeds with reference to the accompanying figures.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detailed description serve to explain the principles of the invention. In the drawings:

FIG. 1 shows an exemplary process for development of dietary supplements.

FIG. 2 shows an exemplary process for computational aspects of development of dietary supplements.

FIG. 3 shows an exemplary flow diagram for development of a dietary supplement pursuant to the disclosed process.

### DETAILED DESCRIPTION

To formulate a dietary supplement that will be safe and effective, one or a series of datasets are created and used, which will provide safe and effective ranges of ingredients that may be included in the dietary supplement. A dietary supplement formulator then may create a dietary supplement using one or more ingredients within these ranges.

The datasets of the present disclosure are:

Dataset 1, Safety Limits

The safety limit for a particular ingredient in a dietary supplement is determined from the scientific literature and/or from recommendations and guidelines published by internationally recognized health authorities. For example, the Institute of Medicine (National Institutes of Health, USA) publishes Upper Limits (ULs) for vitamins, minerals and trace elements commonly present in foods and dietary supplements. The European Food Safety Authority (EFSA) also published a set of ULs (Tolerable Upper Intake Levels for Vitamins and Minerals; Scientific Committee on Food, Scientific Panel on Dietetic Products, Nutrition and Allergies, EFSA 2006, www.efsa.eu.int). Likewise, the United Kingdom has also published a set of ULs for vitamins and minerals (Safe upper levels for vitamins and minerals: report of the expert group on vitamins and minerals; 2003, cot.food.gov.uk/cotreports/cotjointreps/evmreport/). The disclosed method uses a set of ULs that has been developed by the Council for Responsible Nutrition (CRN, USA) using the ULs mentioned above plus additional data (Vitamin and Mineral Safety 3rd Edition, 2013; Council for Responsible Nutrition; www.crnusa.org). This is not only the most complete set of ULs but also the only set that has been specifically developed for use in dietary supplements. The CRN ULs (and other ULs) can be expected to be updated periodically as new safety evidence becomes available. The most recently updated set of ULs may be used in the present method. As of this disclosure, those ULs are shown in Table 1.

These UL data exist for vitamins, minerals and trace elements, but typically not for other dietary supplement ingredients, i.e. the non-essential, semi-essential or conditionally essential nutrients that are present in foods, such as carotenoids and flavonoids. For some of these nutrients, this disclosure provides upper limits shown in Table 1 that were derived from the published literature and regulatory files. For example, the scientific literature provides publications of No Observed Adverse Effect Levels (NOAELs) for many dietary ingredients that are used in supplements. The U.S. Food and Drug Administration (FDA) also provides regulations and guidance to establish safety of food and dietary supplement ingredients. One of these is the GRAS Notification Program. “GRAS” is an acronym for the phrase Generally Recognized As Safe. Under sections 201(s) and 409 of the United States Federal Food, Drug, and Cosmetic Act, any substance that is intentionally added to food is a food additive and it is subject to premarket review and approval by FDA, unless the substance is generally recognized, among qualified experts, as having been adequately shown to be safe under the conditions of its intended use, or unless the use of the substance is otherwise excluded from the definition of a food additive. GRAS submissions can be accessed at http://www.fda.gov/Food/IngredientsPackagingLabeling/GRAS/default.htm. It is important to note, however, that there are many of these non-vitamin/mineral micronutrients that do not have sufficient safety data and therefore have no published ULs, NOAELs or GRAS submissions at the present time. For the purpose of this disclosure, Table 1 provides ULs for commonly used dietary supplements. When formulating specialty dietary supplements with ingredients other than those listed in Table 1, the formulator will have to consult the current scientific literature.

TABLE 1
Upper Limits of Dietary Supplement Ingredients for adults (18+ yrs.)

| Upper Limits, CRN-listed Nutrients | | | Upper Limits, Other Nutrients | | |
|---|---|---|---|---|---|
| Vitamin A (retinol and | 1,500 | mcg (w/high | Choline | 3,500 | mg |
| its esters) | | dietary retinol) | | | |
| Beta-Carotene | 25 | mg (non-smokers) | Vanadium | 1,800 | mcg |
| Vitamin D | 250 | mcg (10,000 IU) | Long-Chain n-3 Fatty | 3,000 | mg |
| | | | Acids (EPA + DHA) | | |
| Vitamin E | 1,000 | mg (1,600 IU) | Alpha-Linolenic Acid | 25 | g |
| Vitamin K | 10 | mg | Lutein | 17.6 | mg |
| Vitamin C | 2,000 | mg | Zeaxanthin | 10 | mg |
| Vitamin B₁ (thiamin) | 100 | mg | Lycopene | 11.3 | mg |
| Vitamin B₂ (riboflavin) | 200 | mg | Alpha-Carotene | 8.3 | mg |
| Nicotinic Acid | 250 | mg | Astaxanthin | 5.3 | mg |
| Nicotinamide | 1,500 | mg | Flavonols (quercetin, | 1,500 | mg |
| | | | etc.) | | |
| Vitamin B₆ | 100 | mg | Flavan-3-ols (mono-, | 300 | mg |
| (pyridoxine) | | | oligo-, poly-meric) | | |
| Folic Acid | 1,000 | mcg | | | |
| Vitamin B₁₂ | 3,000 | mcg | | | |
| Biotin | 2,500 | mcg | | | |
| Pantothenic Acid | 1,000 | mg | | | |
| Calcium | 1,500 | mg | | | |
| Phosphorus | 1,500 | mg | | | |
| Magnesium | 400 | mg | | | |
| Potassium | 1,500 | mg | | | |
| Boron | 6 | mg | | | |
| Chromium | 1,000 | mcg | | | |
| Copper | 9 | mg | | | |
| Iodine | 500 | mcg | | | |
| Iron | 60 | mg | | | |
| Manganese | 10 | mg | | | |
| Molybdenum | 350 | mcg | | | |
| Selenium | 200 | mcg | | | |
| Zinc | 30 | mg | | | |

Dataset 2, Clinical Efficacy

The Clinical Efficacy of a particular ingredient in a dietary supplement is the amount of the ingredient that has been shown to provide a subject with beneficial health effects. Generally, the minimum- and maximum-effective dosages used in human studies are published in the scientific literature, and have been summarized in Table 2 for the purpose of practicing the disclosed method. For the essential vitamins, minerals and trace elements, the minimum clinically effective dosage is considered to be 10% of the highest Dietary Reference Intake (Institute of Medicine) for adults. The effective dosage ranges tend to be broad, because they include efficacy for a variety of health benefits for each nutrient. The list of nutrients in Table 2 only includes commonly used ingredients for dietary supplements for practical reasons. For the development of specialty dietary supplements there may be other nutrients not listed in Table 2 for which the formulator will need to review the currently published literature to determine Clinical Efficacy.

TABLE 2
Clinically Effective Daily Dosages of Dietary Supplement Ingredients
for adults (18+ yrs.)

| | Clinically Effective | |
|---|---|---|
| Dietary Supplement Ingredient | Dosage Range | |
| Vitamin A (retinol and its esters) | 90-3,300 | mcg |
| Beta-Carotene | 1-180 | mg |
| Vitamin D | 2-250 | mcg |
| Vitamin E | 1.5-1,342 | mg |
| Vitamin K | 12-1,000 | mcg |
| Vitamin C | 9-10,000 | mg |
| Vitamin B₁ (thiamin) | 0.12-1,000 | mg |
| Vitamin B₂ (riboflavin) | 0.13-400 | mg |
| Nicotinic Acid | 1.6-3,000 | mg |
| Nicotinamide | 1.6-3,000 | mg |
| Vitamin B₆ (pyridoxine) | 0.17-200 | mg |
| Folic Acid | 40-5,000 | mcg |
| Vitamin B₁₂ | 0.24-2,500 | mcg |
| Biotin | 3-15,000 | mcg |
| Pantothenic Acid | 0.5-200 | mg |
| Calcium | 130-2,000 | mg |
| Phosphorus | 125-2,000 | mg |
| Magnesium | 42-1,200 | mg |
| Potassium | 470-5,000 | mg |
| Boron | 0.2-11.6 | mg |
| Chromium | 3.5-1,000 | mcg |
| Copper | 0.09-8 | mg |
| Iodine | 15-6,000 | mcg |
| Iron | 1.8-120 | mg |
| Manganese | 0.23-30 | mg |
| Molybdenum | 4.5-467 | mcg |
| Selenium | 5.5-200 | mcg |
| Zinc | 1.1-80 | mg |
| Choline | 55-6,000 | mg |
| Vanadium | 20-200,000 | mcg |
| Long-Chain n-3 Fatty Acids (EPA + DHA) | 50-4,000 | mg |
| Lutein | 0.1-20 | mg |
| Zeaxanthin | 0.01-10 | mg |
| Lycopene | 0.2-30 | mg |
| Alpha-Carotene | 0.01-5 | mg |
| Astaxanthin | 4-100 | mg |
| Flavonols (quercetin, etc.) | 10-1,000 | mg |
| Flavan-3-ols (mono-, oligo-, poly-meric) | 2.6-1,072 | mg |

Dataset 3, Paleolithic Intake

The Paleolithic Intake is an estimate of the average intake of a nutrient by a human during the Paleolithic period which spans the evolution of the human species starting at 2.5 million years ago and ending with the introduction of agriculture about 10,000 years ago. Starting with the Mesolithic period 10,000 years ago, human diets have changed significantly, initially by introducing cereal grains, beans, and dairy foods, and more recently by including highly refined and processed foods, such as oils, sugar, and processed meats. As a result, today's nutrient intakes are very different from Paleolithic intakes, while the human genome has changed very little over the past 10,000 years and largely has been unable to adapt to modern nutritional habits and nutrient intakes.

Therefore, using Paleolithic Intake as a factor is an important safety measure in the present invention and acts as a guide on the amount of a particular ingredient in a supplement to ensure that dietary supplements provide only those nutrient types and amounts that humans were exposed and genetically adapted to throughout evolution. This important feature of the present disclosure effectively eliminates the use of non-physiological mega-doses or pharmacological nutrient doses that are prone to produce unexpected safety problems. For the disclosed method, the Paleolithic Intake is determined by an exhaustive review of the literature as well as reasonable estimates based on the types of foods consumed during the Paleolithic period and remaining human populations today that still follow hunter-gatherer lifestyles common during the Paleolithic period (Lindeberg S. Food and Western Disease: Health and Nutrition from an Evolutionary Perspective. Chichester, U.K.: Wiley-Blackwell; 2010. Eaton S B, Eaton S B, 3rd, Konner M J. Paleolithic nutrition revisited: a twelve-year retrospective on its nature and implications. European Journal of Clinical Nutrition. April 1997; 51(4):207-216. Cordain L, Eaton S B, Sebastian A, et al. Origins and evolution of the Western diet: health implications for the 21st century. American Journal of Clinical Nutrition. February 2005; 81(2):341-354.). A reasonable approach to estimate ranges for low to high Paleolithic nutrient intakes is to apply the relative data spread (standard errors, standard deviations or confidence intervals) observed for today's nutrient intakes to the Paleolithic intake estimates. For the purpose of practicing the disclosed method, the Paleolithic Intake ranges for the most commonly used dietary supplement ingredients are disclosed in Table 3. For the development of specialty dietary supplements there may be other nutrients not listed in Table 3 for which the formulator will need to review the currently published literature.

TABLE 3
Estimated Paleolithic Intake Ranges of Dietary Supplement Ingredients
for adults (18+ yrs.)

| Dietary Supplement Ingredient | Paleolithic Intake Range | |
|---|---|---|
| Vitamin A (retinol and its esters) | 1,000-4,000 | mcg |
| Beta-Carotene | 3-9 | mg |
| Vitamin D (from diet and UV exposure) | 20-100 | mcg |
| Vitamin E | 10-60 | mg |
| Vitamin K | 75-300 | mcg |
| Vitamin C | 100-750 | mg |
| Vitamin B₁ (thiamin) | 2-7 | mg |
| Vitamin B₂ (riboflavin) | 3-10 | mg |
| Nicotinic Acid or Nicotinamide | 20-80 | mg |
| Vitamin B₆ (pyridoxine) | 2-10 | mg |
| Folic Acid | 200-600 | mcg |
| Vitamin B₁₂ | 10-75 | mcg |
| Biotin | 40-100 | mcg |
| Pantothenic Acid | 5-20 | mg |
| Calcium | 1,000-2,000 | mg |
| Phosphorus | 1,000-1,800 | mg |
| Magnesium | 300-600 | mg |
| Potassium | 3,000-7,000 | mg |
| Boron | 0.3-3 | mg |
| Chromium | 40-100 | mcg |
| Copper | 1.5-3 | mg |
| Iodine | 50-250 | mcg |
| Iron | 20-100 | mg |
| Manganese | 1-3 | mg |
| Molybdenum | 50-200 | mcg |
| Selenium | 100-250 | mcg |
| Zinc | 20-60 | mg |
| Choline | 300-800 | mg |
| Vanadium | 10-30 | mcg |
| Long-Chain n-3 Fatty Acids (EPA + DHA) | 500-1,500 | mg |
| Lutein | 2-5 | mg |
| Zeaxanthin | 0.2-1 | mg |
| Lycopene | 0.5-4 | mg |
| Alpha-Carotene | 0.25-3 | mg |
| Astaxanthin | 0-4 | mg |
| Flavonols (quercetin, etc.) | 20-100 | mg |
| Flavan-3-ols (mono-, oligo-, poly-meric) | 25-250 | mg |

Dataset 4, Un-Supplemented Intake of Target Consumer

The Un-supplemented Intake of a Target Consumer is the amount of an ingredient in a supplement that a target consumer group likely ingests from food alone before taking dietary supplements. This amount can be subtracted from the ranges already determined to account for unsupplemented intake of ingredients. A Target Consumer is a person having the characteristics of an age and a gender. Information is available for ingredient intakes for groups of people based on age and/or gender. Thus, the formulator chooses the age range and/or gender of the group to whom the supplement will be directed, for example males over 20, and that group is the Target Consumer (a formulator might also choose women of 20, or adult males, or women over 40, and that respective group would be the Target Consumer).

A reference for the Un-supplemented Intake of Target Consumer is the “What We Eat in America” data derived from the National Health and Nutrition Examination Survey (NHANES) which is updated periodically. For the disclosed method, the latest NHANES dataset is used (U.S. Department of Agriculture, Agricultural Research Service. 2012. Nutrient Intakes from Food: Mean Amounts Consumed per Individual, by Gender and Age, What We Eat in America, NHANES 2009-2010. Available at www.ars.usda.gov/ba/bhnrc/fsrg.). For future practice of the disclosed method, the formulator may check for and use updated NHANES datasets available at the USDA website: www.ars.usda.gov/ba/bhnrc/fsrg. The “What We Eat in America” NHANES 2009-2010 data table is shown as Table 4a. It includes the mean amounts consumed in the U.S. for all vitamins, and important minerals, carotenoids and fatty acids. Note that the disclosed method lists the long-chain n-3 fatty acids EPA and DHA as a combined value (EPA+DHA), because they can be interconverted in the body. To find the Un-supplemented Intake of Target Consumers of EPA+DHA in the “What We Eat in America” NHANES 2009-2010 data (Table 4a), the formulator should add the values for “PFA 20:5” and “PFA 22:6”.

Also note that NHANES provides a single value for “lutein+zeaxanthin” due to common analytical difficulties in separately analyzing these two carotenoids. A good estimate to derive the individual values for lutein and zeaxanthin is to apply the generally assumed lutein:zeaxanthin dietary ratio of 5:1. The data is broken down by age group and gender. To calculate a single intake value of a particular nutrient for all adult men and women, it is appropriate to take the average of the values given for “Males 20 and over” and “Females 20 and over”. This also applies to non-gender-specific intakes for any other age group.

TABLE 4(a)

| Gender | Choles- | | | | Vitamin A | | Alpha- | | Beta- | | Beta-crypto- | | | | Lutein + | | | |
|---|---|---|---|---|---|---|---|---|---|---|---|---|---|---|---|---|---|---|
| and age | Terol | | Retinol | | (RAE) | | carotene | | carotene | | xanthin | | Lycopene | | zeaxanthin | | Thiamin | |
| (years) | mg | (SE) | μg | (SE) | μg | (SE) | μg | (SE) | μg | (SE) | μg | (SE) | μg | (SE) | μg | (SE) | mg | (SE) |
| Males: | | | | | | | | | | | | | | | | | | |
| 2-5 . . . | 170 | (8.5) | 491 | (16.4) | 593 | (20.4) | 207 | (28.5) | 1086 | (84.0) | 71 | (10.7) | 3344 | (344.5) | 610 | (41.9) | 1.30 | (0.032) |
| 6-11 . . . | 206 | (8.5) | 529 | (24.2) | 638 | (23.7) | 285 | (52.6) | 1131 | (138.5) | 68 | (7.6) | 4043 | (185.3) | 649 | (50.0) | 1.58 | (0.046) |
| 12-19 . . . | 286 | (15.1) | 541 | (38.9) | 647 | (42.4) | 234 | (45.8) | 1114 | (121.7) | 77 | (8.4) | 6353 | (710.3) | 847 | (72.6) | 1.98 | (0.102) |
| 20-29 . . . | 331 | (13.4) | 480 | (26.6) | 613 | (33.4) | 327 | (33.8) | 1403 | (121.1) | 67 | (8.6) | 6263 | (486.2) | 985 | (84.3) | 1.99 | (0.090) |
| 30-39 . . . | 345 | (17.7) | 479 | (23.8) | 650 | (28.4) | 374 | (47.2) | 1828 | (172.0) | 87 | (8.2) | 7889 | (953.9) | 1358 | (117.7) | 2.07 | (0.067) |
| 40-49 . . . | 357 | (11.4) | 478 | (17.2) | 734 | (40.1) | 555 | (160.9) | 2747 | (429.6) | 100 | (15.6) | 7479 | (1146.8) | 1660 | (341.1) | 2.07 | (0.063) |
| 50-59 . . . | 351 | (19.3) | 502 | (24.7) | 695 | (25.5) | 388 | (53.4) | 2081 | (177.0) | 91 | (7.6) | 5515 | (385.1) | 1650 | (131.9) | 1.90 | (0.054) |
| 60-69 . . . | 305 | (12.5) | 448 | (27.6) | 694 | (41.1) | 481 | (80.3) | 2669 | (404.6) | 90 | (9.7) | 6308 | (838.8) | 1920 | (346.6) | 1.82 | (0.057) |
| 70 and over | 265 | (13.8) | 517 | (31.1) | 738 | (48.5) | 426 | (58.0) | 2391 | (272.6) | 98 | (9.8) | 4546 | (441.6) | 1466 | (126.3) | 1.68 | (0.047) |
| 20 and over | 333 | (6.8) | 483 | (11.1) | 682 | (18.6) | 421 | (39.5) | 2132 | (126.2) | 88 | (3.3) | 6489 | (451.9) | 1480 | (117.8) | 1.95 | (0.031) |
| Females: | | | | | | | | | | | | | | | | | | |
| 2-5 . . . | 178 | (5.9) | 489 | (23.6) | 591 | (26.5) | 261 | (73.4) | 1061 | (166.3) | 74 | (8.7) | 3162 | (254.8) | 695 | (64.9) | 1.23 | (0.035) |
| 6-11 . . . | 185 | (5.6) | 443 | (19.4) | 544 | (20.5) | 233 | (43.0) | 1059 | (113.6) | 67 | (6.0) | 4973 | (697.2) | 771 | (65.7) | 1.50 | (0.040) |
| 12-19 . . . | 211 | (9.6) | 400 | (21.5) | 516 | (26.0) | 252 | (36.7) | 1237 | (81.5) | 49 | (6.6) | 4690 | (439.7) | 854 | (85.1) | 1.41 | (0.048) |
| 20-29 . . . | 238 | (12.1) | 398 | (21.8) | 548 | (26.1) | 349 | (44.2) | 1598 | (163.3) | 64 | (8.1) | 5034 | (432.9) | 1113 | (83.3) | 1.45 | (0.026) |
| 30-39 . . . | 228 | (9.9) | 397 | (16.6) | 590 | (25.7) | 367 | (49.8) | 2087 | (262.7) | 96 | (10.7) | 5026 | (421.5) | 1148 | (184.8) | 1.44 | (0.032) |
| 40-49 . . . | 221 | (10.0) | 343 | (16.0) | 556 | (30.7) | 475 | (107.6) | 2278 | (312.6) | 77 | (10.2) | 4359 | (524.9) | 1604 | (221.3) | 1.38 | (0.056) |
| 50-59 . . . | 228 | (13.9) | 420 | (29.5) | 702 | (49.9) | 490 | (65.3) | 3097 | (375.1) | 98 | (14.7) | 4238 | (318.5) | 2428 | (350.6) | 1.41 | (0.043) |
| 60-69 . . . | 232 | (8.6) | 425 | (23.7) | 648 | (24.0) | 445 | (65.0) | 2406 | (208.7) | 107 | (16.8) | 4580 | (566.2) | 1615 | (128.7) | 1.34 | (0.047) |
| 70 and over | 190 | (6.5) | 395 | (12.6) | 612 | (18.3) | 434 | (40.3) | 2349 | (168.4) | 97 | (13.1) | 3651 | (371.5) | 1533 | (125.6) | 1.34 | (0.039) |
| 20 and over | 224 | (3.6) | 394 | (8.3) | 606 | (11.0) | 427 | (26.6) | 2295 | (84.2) | 88 | (6.1) | 4510 | (192.8) | 1628 | (90.2) | 1.40 | (0.012) |
| Males and | | | | | | | | | | | | | | | | | | |
| Females: | | | | | | | | | | | | | | | | | | |
| 2 and over | 261 | (4.3) | 448 | (5.8) | 628 | (9.4) | 379 | (16.8) | 1942 | (49.4) | 82 | (3.2) | 5263 | (214.4) | 1356 | (77.7) | 1.63 | (0.012) |

| Gender | Ribo- | | | | | | | | Food | | Folate | | | | | | Added | |
|---|---|---|---|---|---|---|---|---|---|---|---|---|---|---|---|---|---|---|
| and age | flavin | | Niacin | | Vitamin B₆ | | Folic acid | | folate | | (DFE) | | Choline | | Vitamin B₁₂ | | Vitamin B₁₂ | |
| (years) | mg | (SE) | mg | (SE) | mg | (SE) | μg | (SE) | μg | (SE) | μg | (SE) | mg | (SE) | μg | (SE) | μg | (SE) |
| Males: | | | | | | | | | | | | | | | | | | |
| 2-5 . . . | 1.83 | (0.054) | 16.4 | (0.39) | 1.47 | (0.038) | 173 | (6.9) | 134 | (4.2) | 428 | (11.7) | 222 | (6.4) | 4.41 | (0.160) | 1.00 | (0.079) |
| 6-11 . . . | 2.05 | (0.057) | 21.0 | (0.61) | 1.65 | (0.054) | 226 | (11.6) | 156 | (4.5) | 540 | (23.3) | 256 | (6.7) | 4.90 | (0.158) | 1.03 | (0.071) |
| 12-19 . . . | 2.41 | (0.126) | 29.9 | (1.08) | 2.31 | (0.120) | 262 | (24.9) | 193 | (6.4) | 639 | (46.1) | 333 | (13.2) | 6.30 | (0.264) | 1.28 | (0.121) |
| 20-29 . . . | 2.33 | (0.109) | 32.4 | (1.28) | 2.56 | (0.156) | 230 | (10.9) | 244 | (10.6) | 635 | (23.3) | 390 | (14.1) | 6.03 | (0.323) | 1.27 | (0.188) |
| 30-39 . . . | 2.58 | (0.096) | 35.0 | (1.09) | 2.85 | (0.106) | 245 | (14.6) | 270 | (8.4) | 687 | (27.0) | 427 | (13.8) | 6.64 | (0.397) | 1.48 | (0.241) |
| 40-49 . . . | 2.71 | (0.086) | 33.9 | (1.14) | 2.68 | (0.105) | 234 | (13.8) | 277 | (13.5) | 675 | (27.8) | 446 | (11.0) | 6.86 | (0.206) | 1.08 | (0.154) |
| 50-59 . . . | 2.58 | (0.083) | 29.8 | (0.83) | 2.32 | (0.090) | 181 | (7.6) | 269 | (9.7) | 577 | (12.9) | 430 | (15.4) | 5.90 | (0.333) | 0.77 | (0.095) |
| 60-69 . . . | 2.34 | (0.088) | 27.0 | (0.80) | 2.20 | (0.069) | 191 | (11.9) | 255 | (10.0) | 580 | (24.8) | 384 | (9.6) | 6.11 | (0.260) | 0.95 | (0.127) |
| 70 and over | 2.24 | (0.066) | 24.4 | (0.67) | 2.11 | (0.084) | 213 | (12.5) | 207 | (5.6) | 569 | (25.5) | 332 | (12.4) | 5.98 | (0.326) | 1.47 | (0.147) |
| 20 and over | 2.49 | (0.038) | 31.2 | (0.42) | 2.50 | (0.039) | 218 | (4.9) | 258 | (3.9) | 628 | (11.5) | 409 | (4.8) | 6.28 | (0.124) | 1.16 | (0.051) |
| Females: | | | | | | | | | | | | | | | | | | |
| 2-5 . . . | 1.85 | (0.060) | 15.3 | (0.28) | 1.38 | (0.033) | 174 | (9.4) | 128 | (3.8) | 423 | (16.9) | 224 | (5.5) | 4.42 | (0.184) | 0.91 | (0.065) |
| 6-11 . . . | 1.83 | (0.052) | 19.7 | (0.49) | 1.52 | (0.056) | 208 | (10.3) | 148 | (3.5) | 502 | (19.0) | 231 | (5.0) | 4.32 | (0.168) | 0.98 | (0.101) |
| 12-19 . . . | 1.72 | (0.054) | 20.0 | (0.68) | 1.53 | (0.059) | 206 | (12.2) | 152 | (6.1) | 502 | (22.2) | 237 | (7.6) | 4.01 | (0.238) | 0.75 | (0.088) |
| 20-29 . . . | 1.79 | (0.061) | 22.6 | (0.68) | 1.80 | (0.080) | 183 | (6.3) | 174 | (6.1) | 485 | (12.3) | 269 | (9.3) | 4.69 | (0.251) | 0.94 | (0.083) |
| 30-39 . . . | 1.93 | (0.054) | 21.1 | (0.36) | 1.81 | (0.070) | 184 | (7.5) | 197 | (7.4) | 509 | (18.1) | 277 | (7.8) | 4.73 | (0.203) | 1.19 | (0.144) |
| 40-49 . . . | 1.78 | (0.048) | 20.5 | (0.57) | 1.63 | (0.052) | 153 | (13.2) | 195 | (5.9) | 456 | (24.6) | 277 | (10.2) | 4.57 | (0.820) | 0.55 | (0.104) |
| 50-59 . . . | 1.92 | (0.056) | 21.5 | (0.63) | 1.82 | (0.076) | 157 | (10.4) | 220 | (7.4) | 487 | (20.5) | 291 | (13.1) | 4.82 | (0.372) | 1.01 | (0.159) |
| 60-69 . . . | 1.90 | (0.062) | 19.9 | (0.55) | 1.64 | (0.049) | 144 | (9.2) | 204 | (7.1) | 448 | (18.5) | 282 | (8.0) | 4.60 | (0.245) | 0.78 | (0.092) |
| 70 and over | 1.76 | (0.045) | 18.6 | (0.58) | 1.66 | (0.066) | 160 | (8.0) | 178 | (5.2) | 450 | (16.5) | 249 | (6.2) | 4.18 | (0.240) | 0.99 | (0.115) |
| 20 and over | 1.85 | (0.024) | 20.8 | (0.24) | 1.73 | (0.026) | 164 | (4.2) | 195 | (2.1) | 474 | (7.7) | 275 | (4.0) | 4.61 | (0.148) | 0.90 | (0.045) |
| Males and | | | | | | | | | | | | | | | | | | |
| Females: | | | | | | | | | | | | | | | | | | |
| 2 and over | 2.11 | (0.017) | 24.7 | (0.20) | 2.00 | (0.021) | 196 | (4.0) | 208 | (2.0) | 541 | (7.6) | 319 | (3.7) | 5.26 | (0.068) | 1.02 | (0.029) |

| Gender | | | | | Vitamin E | | Added | | | | | | | | | |
|---|---|---|---|---|---|---|---|---|---|---|---|---|---|---|---|---|
| and age | Vitamin C | | Vitamin D | | (alpha-tocopherol) | | Vitamin E | | Vitamin K | | Calcium | | Phosphorus | | Magnesium | |
| (years) | mg | (SE) | μg | (SE) | mg | (SE) | mg | (SE) | μg | (SE) | mg | (SE) | mg | (SE) | mg | (SE) |
| Males: | | | | | | | | | | | | | | | | |
| 2-5 . . . | 82.9 | (4.41) | 6.8 | (0.29) | 5.0 | (0.20) | 0.5 | (0.09) | 40.6 | (2.38) | 1034 | (38.3) | 1137 | (32.1) | 213 | (3.1) |
| 6-11 . . . | 73.7 | (5.07) | 6.7 | (0.24) | 6.0 | (0.15) | 0.6 | (0.10) | 52.2 | (3.52) | 1127 | (38.1) | 1321 | (35.6) | 236 | (5.8) |
| 12-19 . . . | 87.7 | (6.94) | 6.4 | (0.40) | 7.8 | (0.36) | 0.5 | (0.09) | 65.8 | (3.30) | 1260 | (58.6) | 1640 | (62.2) | 299 | (8.9) |
| 20-29 . . . | 102.4 | (8.81) | 5.5 | (0.27) | 8.3 | (0.48) | 0.6* | (0.19) | 81.8 | (8.87) | 1240 | (41.9) | 1686 | (53.5) | 334 | (14.0) |
| 30-39 . . . | 95.9 | (4.47) | 5.3 | (0.36) | 9.7 | (0.34) | 1.0 | (0.23) | 101.4 | (6.62) | 1179 | (31.0) | 1759 | (44.4) | 370 | (11.6) |
| 40-49 . . . | 99.0 | (9.28) | 6.3 | (0.60) | 9.6 | (0.35) | 0.6* | (0.30) | 102.5 | (8.84) | 1235 | (39.0) | 1815 | (44.1) | 386 | (10.9) |
| 50-59 . . . | 91.9 | (5.05) | 6.1 | (0.32) | 8.7 | (0.31) | 0.7* | (0.30) | 117.4 | (5.48) | 1142 | (34.9) | 1669 | (51.3) | 353 | (8.1) |
| 60-69 . . . | 89.4 | (3.43) | 6.0 | (0.33) | 8.5 | (0.29) | 0.4* | (0.13) | 126.3 | (16.16) | 1022 | (45.9) | 1498 | (29.6) | 331 | (5.8) |
| 70 and over | 90.0 | (7.02) | 5.8 | (0.40) | 8.2 | (0.37) | 0.8 | (0.13) | 99.1 | (6.57) | 895 | (34.9) | 1272 | (31.3) | 290 | (7.5) |
| 20 and over | 95.6 | (2.29) | 5.9 | (0.18) | 8.9 | (0.16) | 0.7 | (0.12) | 103.8 | (5.37) | 1146 | (14.5) | 1655 | (18.7) | 349 | (4.6) |
| Females: | | | | | | | | | | | | | | | | |
| 2-5 . . . | 83.4 | (4.69) | 6.9 | (0.32) | 4.6 | (0.14) | 0.4 | (0.08) | 44.8 | (3.69) | 1030 | (41.5) | 1136 | (34.4) | 205 | (5.9) |
| 6-11 . . . | 73.8 | (4.23) | 5.4 | (0.23) | 5.7 | (0.18) | 0.5 | (0.10) | 54.0 | (2.94) | 963 | (31.2) | 1201 | (34.1) | 226 | (6.9) |
| 12-19 . . . | 77.8 | (6.15) | 4.7 | (0.31) | 6.5 | (0.27) | 0.5* | (0.15) | 60.3 | (4.04) | 948 | (26.8) | 1192 | (33.4) | 224 | (5.7) |
| 20-29 . . . | 78.5 | (4.99) | 4.3 | (0.25) | 6.4 | (0.22) | 0.5 | (0.09) | 79.2 | (4.37) | 935 | (24.6) | 1222 | (31.2) | 252 | (7.9) |
| 30-39 . . . | 78.8 | (3.53) | 4.8 | (0.29) | 7.6 | (0.37) | 0.8 | (0.11) | 90.9 | (9.06) | 960 | (32.3) | 1260 | (29.6) | 282 | (8.2) |
| 40-49 . . . | 79.0 | (5.78) | 4.1 | (0.22) | 6.8 | (0.27) | 0.3 | (0.09) | 108.6 | (11.76) | 874 | (17.9) | 1181 | (28.1) | 270 | (6.9) |
| 50-59 . . . | 99.4 | (10.81) | 4.6 | (0.51) | 8.2 | (0.39) | 1.2 | (0.29) | 151.5 | (16.75) | 890 | (30.3) | 1202 | (31.4) | 283 | (6.1) |
| 60-69 . . . | 79.5 | (4.45) | 4.7 | (0.26) | 7.3 | (0.26) | 0.6 | (0.10) | 107.8 | (8.09) | 872 | (23.9) | 1183 | (29.7) | 268 | (5.6) |
| 70 and over | 79.5 | (3.33) | 4.4 | (0.14) | 6.3 | (0.26) | 0.6 | (0.12) | 102.2 | (6.60) | 813 | (12.9) | 1061 | (18.4) | 243 | (5.2) |
| 20 and over | 82.7 | (2.40) | 4.5 | (0.15) | 7.1 | (0.10) | 0.7 | (0.05) | 106.9 | (3.97) | 895 | (11.3) | 1190 | (11.8) | 267 | (2.6) |
| Males and | | | | | | | | | | | | | | | | |
| Females: | | | | | | | | | | | | | | | | |
| 2 and over | 86.6 | (1.40) | 5.3 | (0.11) | 7.5 | (0.10) | 0.6 | (0.05) | 92.7 | (3.52) | 1029 | (7.1) | 1386 | (7.6) | 290 | (2.0) |

| Gender | | | | | | | | | | | | | | | | | | |
|---|---|---|---|---|---|---|---|---|---|---|---|---|---|---|---|---|---|---|
| and age | Iron | | Zinc | | Copper | | Selenium | | Potassium | | Sodium² | | Caffeine | | Theobromine | | Alcohol³ | |
| (years) | mg | (SE) | mg | (SE) | mg | (SE) | μg | (SE) | mg | (SE) | mg | (SE) | mg | (SE) | mg | (SE) | g | (SE) |
| Males: | | | | | | | | | | | | | | | | | | |
| 2-5 . . . | 11.6 | (0.26) | 8.8 | (0.18) | 0.8 | (0.02) | 73.8 | (1.02) | 2092 | (37.3) | 2331 | (70.6) | 6.0 | (0.70) | 43.4 | (4.12) | — | — |
| 6-11 . . . | 14.0 | (0.38) | 10.3 | (0.29) | 1.0 | (0.01) | 93.6 | (2.00) | 2248 | (50.2) | 3062 | (62.4) | 18.2 | (1.78) | 64.8 | (4.78) | — | — |
| 12-19 . . . | 17.6 | (0.60) | 13.9 | (0.41) | 1.3 | (0.06) | 129.8 | (5.54) | 2750 | (112.5) | 4211 | (156.9) | 66.3 | (11.12) | 51.3 | (5.42) | — | — |
| 20-29 . . . | 17.5 | (0.76) | 13.7 | (0.72) | 1.4 | (0.06) | 138.3 | (4.85) | 2911 | (121.5) | 4376 | (111.7) | 124.0 | (13.82) | 36.0 | (6.60) | — | — |
| 30-39 . . . | 18.9 | (0.73) | 15.3 | (0.60) | 1.6 | (0.05) | 145.0 | (3.97) | 3207 | (80.3) | 4533 | (105.3) | 187.9 | (18.79) | 38.8 | (3.50) | — | — |
| 40-49 . . . | 18.6 | (0.60) | 15.6 | (0.43) | 1.6 | (0.06) | 144.2 | (4.38) | 3504 | (106.9) | 4588 | (162.5) | 253.3 | (22.34) | 50.0 | (4.85) | — | — |
| 50-59 . . . | 16.6 | (0.50) | 14.3 | (0.67) | 1.5 | (0.06) | 131.3 | (4.28) | 3311 | (93.4) | 4253 | (151.7) | 282.0 | (19.41) | 52.4 | (6.00) | — | — |
| 60-69 . . . | 16.3 | (0.54) | 12.8 | (0.32) | 1.4 | (0.03) | 123.4 | (3.34) | 3119 | (84.5) | 3900 | (80.2) | 220.5 | (15.75) | 36.8 | (6.05) | — | — |
| 70 and over | 16.4 | (0.55) | 12.1 | (0.32) | 1.3 | (0.06) | 102.0 | (2.43) | 2797 | (74.8) | 3205 | (72.7) | 174.8 | (15.93) | 39.0 | (3.48) | — | — |
| 20 and over | 17.5 | (0.21) | 14.2 | (0.22) | 1.5 | (0.02) | 133.7 | (1.98) | 3172 | (43.9) | 4243 | (42.9) | 208.6 | (10.70) | 42.7 | (2.09) | 17.2 | (1.26) |
| Females: | | | | | | | | | | | | | | | | | | |
| 2-5 . . . | 11.3 | (0.37) | 8.4 | (0.25) | 0.8 | (0.03) | 73.2 | (1.74) | 2046 | (53.1) | 2283 | (57.0) | 5.7 | (0.56) | 45.7 | (5.82) | — | — |
| 6-11 . . . | 13.5 | (0.34) | 9.5 | (0.25) | 1.0 | (0.03) | 87.6 | (2.17) | 2092 | (54.2) | 2875 | (66.1) | 16.1 | (0.99) | 68.1 | (6.81) | — | — |
| 12-19 . . . | 12.9 | (0.45) | 9.3 | (0.29) | 1.0 | (0.03) | 91.1 | (1.69) | 2008 | (55.8) | 2958 | (95.5) | 48.4 | (4.28) | 50.2 | (3.64) | — | — |
| 20-29 . . . | 13.5 | (0.33) | 10.0 | (0.26) | 1.1 | (0.05) | 96.3 | (2.29) | 2227 | (56.8) | 3217 | (74.3) | 107.6 | (7.62) | 34.4 | (4.58) | — | — |
| 30-39 . . . | 14.1 | (0.38) | 10.2 | (0.26) | 1.2 | (0.04) | 94.6 | (2.06) | 2420 | (40.5) | 3050 | (63.1) | 155.8 | (12.22) | 38.2 | (3.76) | — | — |
| 40-49 . . . | 12.9 | (0.49) | 9.9 | (0.33) | 1.1 | (0.04) | 96.5 | (3.66) | 2391 | (69.1) | 3014 | (74.1) | 168.8 | (12.22) | 42.5 | (4.09) | — | — |
| 50-59 . . . | 13.1 | (0.44) | 9.8 | (0.30) | 1.2 | (0.04) | 95.8 | (3.21) | 2592 | (53.8) | 2992 | (79.9) | 186.1 | (15.95) | 38.7 | (4.12) | — | — |
| 60-69 . . . | 12.7 | (0.53) | 9.6 | (0.26) | 1.3 | (0.05) | 93.0 | (3.35) | 2488 | (52.0) | 2891 | (79.1) | 166.8 | (14.61) | 44.5 | (4.60) | — | — |
| 70 and over | 12.6 | (0.37) | 9.5 | (0.32) | 1.1 | (0.03) | 81.4 | (2.38) | 2339 | (36.5) | 2588 | (65.3) | 121.9 | (11.93) | 33.5 | (2.79) | — | — |
| 20 and over | 13.2 | (0.18) | 9.8 | (0.17) | 1.2 | (0.02) | 93.6 | (1.12) | 2408 | (22.2) | 2980 | (29.9) | 152.2 | (7.79) | 38.7 | (1.92) | 5.8 | (0.48) |
| Males and | | | | | | | | | | | | | | | | | | |
| Females: | | | | | | | | | | | | | | | | | | |
| 2 and over | 14.9 | (0.11) | 11.5 | (0.11) | 1.2 | (0.01) | 108.5 | (0.99) | 2640 | (18.0) | 3463 | (19.4) | 142.4 | (6.33) | 44.1 | (1.66) | — | — |

| Gender | | | | | | | | | | | | | | | | |
|---|---|---|---|---|---|---|---|---|---|---|---|---|---|---|---|---|
| and age | SFA 4:0 | | SFA 6:0 | | SFA 8:0 | | SFA 10:0 | | SFA 12:0 | | SFA 14:0 | | SFA 16:0 | | SFA 18:0 | |
| (years) | g | (SE) | g | (SE) | g | (SE) | g | (SE) | g | (SE) | g | (SE) | g | (SE) | g | (SE) |
| Males: | | | | | | | | | | | | | | | | |
| 2-5 . . . | 0.51 | (0.035) | 0.31 | (0.022) | 0.27 | (0.016) | 0.45 | (0.022) | 0.59 | (0.038) | 1.86 | (0.111) | 10.16 | (0.352) | 4.68 | (0.155) |
| 6-11 . . . | 0.57 | (0.034) | 0.33 | (0.020) | 0.26 | (0.018) | 0.49 | (0.028) | 0.75 | (0.056) | 2.20 | (0.104) | 12.94 | (0.334) | 6.16 | (0.160) |
| 12-19 . . . | 0.67 | (0.047) | 0.36 | (0.020) | 0.29 | (0.019) | 0.54 | (0.032) | 0.87 | (0.068) | 2.68 | (0.145) | 16.89 | (0.726) | 7.85 | (0.363) |
| 20-29 . . . | 0.62 | (0.027) | 0.35 | (0.016) | 0.27 | (0.015) | 0.52 | (0.022) | 0.77 | (0.072) | 2.60 | (0.105) | 16.71 | (0.615) | 7.78 | (0.292) |
| 30-39 . . . | 0.60 | (0.036) | 0.33 | (0.019) | 0.26 | (0.014) | 0.51 | (0.025) | 0.79 | (0.072) | 2.59 | (0.142) | 17.26 | (0.511) | 7.98 | (0.296) |
| 40-49 . . . | 0.68 | (0.044) | 0.37 | (0.027) | 0.30 | (0.025) | 0.57 | (0.043) | 0.97 | (0.130) | 2.84 | (0.198) | 18.42 | (0.827) | 8.86 | (0.402) |
| 50-59 . . . | 0.67 | (0.043) | 0.38 | (0.024) | 0.30 | (0.020) | 0.57 | (0.036) | 0.90 | (0.112) | 2.74 | (0.170) | 17.48 | (0.589) | 8.15 | (0.313) |
| 60-69 . . . | 0.55 | (0.037) | 0.30 | (0.021) | 0.23 | (0.011) | 0.46 | (0.026) | 0.73 | (0.036) | 2.23 | (0.098) | 14.80 | (0.424) | 6.89 | (0.217) |
| 70 and over | 0.44 | (0.015) | 0.25 | (0.008) | 0.20 | (0.008) | 0.38 | (0.014) | 0.63 | (0.027) | 1.78 | (0.049) | 12.52 | (0.338) | 5.97 | (0.218) |
| 20 and over | 0.61 | (0.019) | 0.34 | (0.010) | 0.26 | (0.008) | 0.51 | (0.015) | 0.82 | (0.049) | 2.54 | (0.076) | 16.62 | (0.355) | 7.80 | (0.186) |
| Females: | | | | | | | | | | | | | | | | |
| 2-5 . . . | 0.57 | (0.051) | 0.35 | (0.029) | 0.28 | (0.015) | 0.47 | (0.032) | 0.67 | (0.026) | 2.07 | (0.138) | 10.51 | (0.412) | 4.89 | (0.202) |
| 6-11 . . . | 0.49 | (0.021) | 0.29 | (0.012) | 0.23 | (0.011) | 0.42 | (0.014) | 0.66 | (0.040) | 1.94 | (0.066) | 11.78 | (0.255) | 5.51 | (0.107) |
| 12-19 . . . | 0.54 | (0.023) | 0.30 | (0.013) | 0.24 | (0.012) | 0.44 | (0.019) | 0.77 | (0.074) | 2.06 | (0.072) | 12.19 | (0.320) | 5.77 | (0.159) |
| 20-29 . . . | 0.51 | (0.031) | 0.29 | (0.019) | 0.22 | (0.013) | 0.42 | (0.023) | 0.65 | (0.042) | 2.04 | (0.113) | 12.61 | (0.578) | 5.97 | (0.272) |
| 30-39 . . . | 0.49 | (0.018) | 0.27 | (0.011) | 0.22 | (0.012) | 0.43 | (0.020) | 0.72 | (0.051) | 1.96 | (0.056) | 11.78 | (0.322) | 5.57 | (0.170) |
| 40-49 . . . | 0.46 | (0.023) | 0.25 | (0.014) | 0.21 | (0.011) | 0.39 | (0.017) | 0.65 | (0.045) | 1.80 | (0.070) | 11.41 | (0.371) | 5.29 | (0.176) |
| 50-59 . . . | 0.46 | (0.032) | 0.25 | (0.015) | 0.20 | (0.012) | 0.38 | (0.024) | 0.63 | (0.047) | 1.74 | (0.096) | 11.36 | (0.408) | 5.30 | (0.174) |
| 60-69 . . . | 0.51 | (0.030) | 0.29 | (0.017) | 0.22 | (0.015) | 0.42 | (0.025) | 0.66 | (0.050) | 1.90 | (0.098) | 11.75 | (0.411) | 5.49 | (0.225) |
| 70 and over | 0.42 | (0.014) | 0.23 | (0.008) | 0.19 | (0.010) | 0.36 | (0.011) | 0.60 | (0.057) | 1.59 | (0.045) | 10.20 | (0.253) | 4.80 | (0.140) |
| 20 and over | 0.48 | (0.011) | 0.26 | (0.006) | 0.21 | (0.004) | 0.40 | (0.009) | 0.65 | (0.019) | 1.85 | (0.030) | 11.56 | (0.116) | 5.42 | (0.051) |
| Males and | | | | | | | | | | | | | | | | |
| Females: | | | | | | | | | | | | | | | | |
| 2 and over | 0.55 | (0.010) | 0.31 | (0.006) | 0.24 | (0.005) | 0.46 | (0.008) | 0.73 | (0.023) | 2.18 | (0.037) | 13.71 | (0.145) | 6.43 | (0.081) |

| Gender | | | | | | | | | | | | | | |
|---|---|---|---|---|---|---|---|---|---|---|---|---|---|---|
| and age | MFA 16:1 | | MFA 18:1 | | MFA 20:1 | | MFA 22:1 | | MFA 18:2 | | MFA 18:3 | | MFA 18:4 | |
| (years) | g | (SE) | g | (SE) | g | (SE) | g | (SE) | g | (SE) | g | (SE) | g | (SE) |
| Males: | | | | | | | | | | | | | | |
| 2-5 . . . | 0.73 | (0.024) | 17.81 | (0.570) | 0.18 | (0.010) | 0.01 | (0.003) | 9.69 | (0.357) | 0.88 | (0.027) | 0.01 | (0.001) |
| 6-11 . . . | 0.97 | (0.037) | 23.24 | (0.527) | 0.23 | (0.008) | 0.01 | (0.001) | 13.07 | (0.371) | 1.17 | (0.041) | 0.01 | (0.002) |
| 12-19 . . . | 1.38 | (0.059) | 30.50 | (1.173) | 0.32 | (0.016) | 0.03 | (0.004) | 17.42 | (0.578) | 1.55 | (0.063) | 0.02 | (0.005) |
| 20-29 . . . | 1.44 | (0.054) | 31.19 | (1.286) | 0.33 | (0.015) | 0.03 | (0.004) | 17.95 | (0.860) | 1.78 | (0.099) | 0.02 | (0.002) |
| 30-39 . . . | 1.58 | (0.067) | 33.49 | (0.775) | 0.36 | (0.013) | 0.04 | (0.004) | 18.80 | (0.540) | 1.77 | (0.034) | 0.02 | (0.002) |
| 40-49 . . . | 1.59 | (0.081) | 35.37 | (1.505) | 0.39 | (0.028) | 0.03 | (0.004) | 19.07 | (0.757) | 1.80 | (0.077) | 0.02 | (0.005) |
| 50-59 . . . | 1.49 | (0.062) | 32.25 | (0.897) | 0.33 | (0.018) | 0.04* | (0.014) | 18.49 | (0.590) | 1.95 | (0.091) | 0.01 | (0.002) |
| 60-69 . . . | 1.27 | (0.047) | 28.98 | (0.852) | 0.33 | (0.019) | 0.07 | (0.019) | 16.41 | (0.579) | 1.70 | (0.083) | 0.02 | (0.002) |
| 70 and over | 1.04 | (0.034) | 25.36 | (0.646) | 0.25 | (0.008) | 0.03 | (0.008) | 14.13 | (0.487) | 1.48 | (0.060) | 0.01 | (0.001) |
| 20 and over | 1.44 | (0.030) | 31.75 | (0.539) | 0.34 | (0.008) | 0.04 | (0.004) | 17.84 | (0.345) | 1.77 | (0.039) | 0.02 | (0.001) |
| Females: | | | | | | | | | | | | | | |
| 2-5 . . . | 0.75 | (0.034) | 17.65 | (0.580) | 0.16 | (0.008) | 0.01 | (0.001) | 9.36 | (0.478) | 0.92 | (0.037) | 0.01 | (0.001) |
| 6-11 . . . | 0.84 | (0.022) | 21.08 | (0.370) | 0.21 | (0.009) | 0.01 | (0.002) | 12.13 | (0.290) | 1.12 | (0.041) | 0.01 | (0.001) |
| 12-19 . . . | 0.91 | (0.035) | 22.05 | (0.587) | 0.21 | (0.012) | 0.02 | (0.004) | 13.69 | (0.594) | 1.22 | (0.037) | 0.01 | (0.002) |
| 20-29 . . . | 1.05 | (0.052) | 23.40 | (0.887) | 0.25 | (0.010) | 0.01 | (0.002) | 13.93 | (0.515) | 1.39 | (0.056) | 0.01 | (0.002) |
| 30-39 . . . | 0.96 | (0.035) | 22.69 | (0.703) | 0.22 | (0.007) | 0.02 | (0.002) | 13.44 | (0.507) | 1.31 | (0.066) | 0.01 | (0.001) |
| 40-49 . . . | 0.92 | (0.030) | 21.35 | (0.686) | 0.24 | (0.021) | 0.02 | (0.005) | 13.55 | (0.579) | 1.37 | (0.069) | 0.01 | (0.004) |
| 50-59 . . . | 0.88 | (0.029) | 22.15 | (0.659) | 0.24 | (0.018) | 0.03 | (0.004) | 13.51 | (0.433) | 1.47 | (0.041) | 0.01 | (0.003) |
| 60-69 . . . | 0.91 | (0.046) | 22.30 | (0.759) | 0.24 | (0.020) | 0.02 | (0.002) | 13.27 | (0.529) | 1.39 | (0.079) | 0.01 | (0.002) |
| 70 and over | 0.78 | (0.027) | 19.04 | (0.520) | 0.18 | (0.009) | 0.02 | (0.005) | 11.89 | (0.321) | 1.34 | (0.051) | 0.01 | (0.001) |
| 20 and over | 0.92 | (0.008) | 21.91 | (0.179) | 0.23 | (0.007) | 0.02 | (0.002) | 13.33 | (0.197) | 1.38 | (0.029) | 0.01 | (0.001) |
| Males and | | | | | | | | | | | | | | |
| Females: | | | | | | | | | | | | | | |
| 2 and over | 1.12 | (0.013) | 25.73 | (0.232) | 0.27 | (0.004) | 0.03 | (0.002) | 14.93 | (0.200) | 1.48 | (0.023) | 0.01 | (0.001) |

| | | | | |
|---|---|---|---|---|
| Gender | | | | |
| and age | PFA 20:4 | PFA 20:5 | PFA 22:5 | PFA 22:6 |

| (years) | g | (SE) | g | (SE) | g | (SE) | g | (SE) |
|---|---|---|---|---|---|---|---|---|
| Males: | | | | | | | | |
| 2-5 . . . | 0.08 | (0.005) | 0.01 | (0.003) | 0.01 | (0.001) | 0.03 | (0.006) |
| 6-11 . . . | 0.10 | (0.005) | 0.01 | (0.002) | 0.01 | (0.001) | 0.03 | (0.004) |
| 12-19 . . . | 0.15 | (0.009) | 0.02 | (0.002 | 0.02 | (0.001) | 0.04 | (0.005) |
| 20-29 . . . | 0.19 | (0.011) | 0.04 | (0.005) | 0.03 | (0.002) | 0.07 | (0.008) |
| 30-39 . . . | 0.19 | (0.009) | 0.04 | (0.006) | 0.03 | (0.003) | 0.09 | (0.012) |
| 40-49 . . . | 0.19 | (0.008) | 0.04 | (0.011) | 0.03 | (0.003) | 0.09 | (0.019) |
| 50-59 . . . | 0.18 | (0.009) | 0.04 | (0.005) | 0.03 | (0.002) | 0.08 | (0.007) |
| 60-69 . . . | 0.16 | (0.009) | 0.06 | (0.006) | 0.03 | (0.002) | 0.10 | (0.013) |
| 70 and over | 0.14 | (0.008) | 0.04 | (0.006) | 0.02 | (0.003) | 0.08 | (0.012) |
| 20 and over | 0.18 | (0.004) | 0.04 | (0.003) | 0.03 | (0.001) | 0.08 | (0.005) |
| Females: | | | | | | | | |
| 2-5 . . . | 0.08 | (0.005) | 0.01 | (0.002) | 0.01 | (0.001) | 0.02 | (0.003) |
| 6-11 . . . | 0.09 | (0.004) | 0.01 | (0.002) | 0.01 | (0.001) | 0.03 | (0.003) |
| 12-19 . . . | 0.11 | (0.006) | 0.02 | (0.002) | 0.01 | (0.001) | 0.03 | (0.003) |
| 20-29 . . . | 0.13 | (0.007) | 0.03 | (0.004) | 0.02 | (0.002) | 0.05 | (0.008) |
| 30-39 . . . | 0.11 | (0.005) | 0.03 | (0.006) | 0.02 | (0.002) | 0.06 | (0.009) |
| 40-49 . . . | 0.12 | (0.008) | 0.04* | (0.017) | 0.02 | (0.003) | 0.07* | (0.022) |
| 50-59 . . . | 0.12 | (0.008) | 0.03 | (0.005) | 0.02 | (0.003) | 0.07 | (0.011) |
| 60-69 . . . | 0.12 | (0.007) | 0.04 | (0.004) | 0.02 | (0.001) | 0.07 | (0.006) |
| 70 and over | 0.09 | (0.005) | 0.02 | (0.004) | 0.02 | (0.002) | 0.05 | (0.006) |
| 20 and over | 0.12 | (0.003) | 0.03 | (0.004) | 0.02 | (0.001) | 0.06 | (0.006) |
| Males and | | | | | | | | |
| Females: | | | | | | | | |
| 2 and over | 0.14 | (0.002) | 0.03 | (0.003) | 0.02 | (0.001) | 0.06 | (0.004) |

(mg = milligrams; μg = micrograms; SE = Standard error; RAE = retinol activity equivalents; DFE = dietary folate equivalents; SFA = saturated fatty acid; MFA = monounsaturated fatty acid; PFA = polyunsaturated fatty acid)

Table 4(b) shows the mean Un-Supplemented Intake of Target Consumers for those vitamins and minerals not listed by “What We Eat in America” NHANES (Table 4(a)). The data in Table 4(b) is derived from published nutrient intake surveys.

TABLE 4(b)
Un-Supplemented Vitamin and Mineral Intakes for adults (18+ yrs.)

Un-Supplemented Intake

| Dietary Supplement Ingredient | Men | | Women | |
|---|---|---|---|---|
| Biotin | 50 | mcg | 50 | mcg |
| Pantothenic Acid | 5 | mg | 4 | mg |
| Boron | 1.33 | mg | 1.00 | mg |
| Chromium | 46.5 | mcg | 25.9 | mcg |
| Iodine | 270 | mcg | 200 | mcg |
| Manganese | 3.4 | mg | 2.7 | mg |
| Molybdenum | 109 | mcg | 76 | mcg |
| Choline | 372 | mg | 304 | mg |
| Vanadium | 12 | mcg | 12 | mcg |

Table 4(c) shows the mean Un-Supplemented Intake of Target Consumers for the two main classes of dietary flavonoids, the flavan-3-ols (such as catechins from tea, cocoa and grapes) and flavones (such as quercetin from onions or red wine). The flavonoid intake data in Table 4(c) is broken down by gender and age; it was derived from a separate analysis performed on the NHANES 1999-2002 data (Chun O K, Chung S J, Song W O, Estimated dietary flavonoid intake and major food sources of U.S. adults, The Journal of Nutrition 2007; 137(5):1244-1252). Chun also provides data for the other main classes of flavonoids in the U.S. by gender and age groups.

TABLE 4(c)
Un-Supplemented Flavonoid Intakes for adults (18+ yrs.)

Un-Supplemented Intake

| Dietary Supplement Ingredient | Flavan-3-ols | Flavonols |
|---|---|---|
| Men, all ages | 157.7 mg | 13.7 mg |
| Men, 19-30 | 162.9 mg | 13.4 mg |
| Men, 31-50 | 157.0 mg | 14.0 mg |
| Men, 51-70 | 169.9 mg | 14.5 mg |
| Men, 70+ | 111.4 mg | 10.7 mg |
| Women, all ages | 155.4 mg | 12.1 mg |
| Women, 19-30 | 120.0 mg | 9.6 mg |
| Women, 31-50 | 161.0 mg | 12.5 mg |
| Women, 51-70 | 187.2 mg | 13.9 mg |
| Women, 70+ | 124.4 mg | 10.8 mg |
| All Adults, all ages | 156.5 mg | 12.9 mg |

Finally, for the development of specialty dietary supplements there may be other nutrients not listed in Tables 4(a-c) for which the formulator will need to review the currently published literature. Likewise, there may be target consumer populations that are not listed in Tables 4(a-c), such as vegans, vegetarians, athletes, pregnant or lactating women, or individuals or patients requiring special diets, for which the formulator will need to review the currently published literature.

To formulate a dietary supplement, a formulator determines which ingredient(s) to select to include in the supplement based on desired product type, health benefits and marketing objectives for the supplement, and for each ingredient determines a range common to datasets 1-3 (e.g., if dataset 1 was 0-12, and dataset 2 was 5-15, and dataset 3 was 10-20, the common range would be 10-12), and subtracts from that range the amount of ingredient in dataset 4 for a particular target consumer group. An amount in the resulting range for the ingredient is a safe and effective amount and is then included in the dietary supplement.

A formulator might also choose to use just a subset of the disclosed datasets to determine a safe and effective amount of an ingredient for inclusion in a dietary supplement. For example, a formulator might just use a range common to the Clinical Efficacy dataset and the Paleolithic Intake dataset, and subtract the Un-supplemented Intake of Target Consumer to determine a range of an amount of an ingredient to include in a dietary supplement. In this example, the Paleolithic Intake dataset would act as an upper limit to prevent a formulator from including more of an ingredient in a dietary supplement than humans generally consumed in the Paleolithic era.

Formulators skilled in the art are familiar with the common practice of selecting the specific types of commercially available dietary supplement raw ingredients based on chemistry, stability, potency, purity and physical characteristics that is appropriate for the desired dosage form (e.g., tablet, hard-shell capsule, soft gelatin capsule, powder).

A formulator skilled in the art will also be aware that for some nutrients the different chemical forms may have different bioavailability, which can be defined as the proportion of the administered substance capable of being absorbed and available for use or storage. For example, folic acid in supplements has a higher bioavailability than folic acid in foods (folates); synthetic vitamin E (all-rac-alpha-tocopherol) used in many supplements has a lower bioavailability than the natural form (RRR-alpha-tocopherol) found in foods; and magnesium oxide has a lower bioavailability than most organic magnesium salts or chelates (citrate, malate, glycinate) commonly present in foods. Depending on the chemical form of the ingredient chosen, the formulator can apply a correction factor to adjust the values of safe and effective ranges for bioavailability.

The following embodiments of the disclosed method illustrate use of the method to formulate a safe and effective dietary supplement.

### Embodiment 1

In this embodiment of the disclosed method, the method is used to create a safe and effective vitamin E dietary supplement intended for the target consumer group of US adults. The vitamin E type to be used in the dietary supplement is RRR-alpha-tocopherol (d-alpha-tocopherol).

Dataset 1, Safety Limits: The UL (Upper Limit) for vitamin E for healthy US adults is 1,000 mg (from Table 1). Therefore the range of safe vitamin E intakes is 0 to 1,000 mg.

Dataset 2, Clinical Efficacy: Published clinical and pharmacokinetic studies show beneficial health effects in adults from 1.5 to 1,342 mg (from Table 2). Therefore, combining datasets 1 and 2, the common range of Clinical Efficacy and Safety Limits for vitamin E intakes is 1.5 to 1,000 mg.

Dataset 3, Paleolithic Intake: The Paleolithic vitamin E intake is 10 to 60 mg (from Table 3).

The formulator, e.g., by using a data processing device, can now determine the overlapping, common range of datasets 1 through 3. In this embodiment, in the case of vitamin E, that is 10 to 60 mg.

Dataset 4, Intake of Target Consumer: According to the NHANES 2009/10 survey (Table 4a), the average vitamin E intake in the U.S. for adults (over age 20) was 8.9 mg for males and 7.1 mg for females. Since the dietary supplement is intended for both genders, it is reasonable to calculate the average, which is 8 mg of vitamin E per day.

The formulator, e.g., by using a data processing device, can now subtract dataset 4 from the common range obtained from datasets 1 through 3, i.e., 10-60 mg arriving at a range of 2-52 mg (if by subtraction an amount is negative, it is simply zero since there cannot be a negative amount of a substance). The disclosed method determines as a result that 2-52 mg is the range of safe and efficacious supplemental amounts of vitamin E.

The formulator can now apply this range of safe and effective supplemental amounts of Vitamin E to create a dietary supplement. Formulators skilled in the art are familiar with the common practice of selecting the specific type of vitamin E based on chemistry, stability, potency, purity and physical characteristics that is appropriate for the desired dosage form (e.g., tablet, hard-shell capsule, soft gelatin capsule, powder). For example, a dietary supplement formulated using the method of the disclosed method may be a tablet providing a total of 45 mg per daily serving of Vitamin E from RRR-alpha-tocopherol succinate.

### Embodiment 2

This embodiment describes a method of developing a safe and effective multivitamin & mineral dietary supplement intended for adult women living in the U.S. This product is designed to contain 12 vitamins, 9 minerals and lutein. The method is described below and the datasets and results are shown in Table 5.

Dataset 1, Safety Limits: The ULs (Upper Limits) for the 22 components of the multivitamin/mineral supplement are taken from Table 1. Using the ULs, the ranges of safe intakes for dataset 1 include intakes from 0 to the UL. The data are taken from Table 1 and entered in Table 5.

Dataset 2, Clinical Efficacy: The data for clinical efficacy are taken from Table 2 and entered in Table 5.

Dataset 3, Paleolithic Intake: The data for Paleolithic Intake ranges are taken from Table 3 and entered in Table 5.

The formulator, e.g., by using a data processing device, can now determine the overlapping, common range of datasets 1 through 3, which is also shown in Table 5.

Dataset 4, Intake of Target Consumer: Since the multivitamin in this example is intended for adult U.S. women, the closest matching dataset for most nutrients is that provided by the “What We Eat in America” NHANES 2009/10 survey for “Females 20 and over” as shown in Table 4a. The remaining nutrients not covered in Table 4a are taken from Table 4b. These data are entered into Table 5.

The formulator, e.g., by using a data processing device, now determines the overlapping, common ranges of datasets 1 through 3 (see Table 5). Then, the formulator subtracts dataset 4 from the common range obtained above from datasets 1 through 3. The resulting range is range of safe and efficacious supplemental amounts of all nutrients to be used in a multivitamin/mineral dietary supplement.

TABLE 5
Summary of calculations and results for developing a multivitamin/mineral
dietary supplement for adult U.S. women

| | | | | | | Dataset 4 | |
|---|---|---|---|---|---|---|---|
| | | | | | Common | Avg. Food | Safe & |
| | | Dataset 1 | Dataset 2 | Dataset 3 | Range | Intake | Effective |
| | | Upper | Clinical | Paleolithic | Datasets | Women | Supplemental |
| Nutrient (Ingredient) | Units | Limits | Efficacy | Intakes | 1-3 | 20+ years | Amounts |
| Vitamin A (retinol) | mcg | 1500 | 90-3300 | 1000-4000 | 1000-1500 | 394 | 606-1106 |
| Vitamin C (ascorbic acid) | mg | 2000 | 9-10000 | 100-750 | 100-750 | 82.7 | 17.3-667.3 |
| Vitamin D (cholecalciferol) | mcg | 250 | 2-250 | 20-100 | 20-100 | 4.5 | 15.5-95.5 |
| Vitamin E (RRR-alpha- | mg | 1000 | 1.5-1342 | 10-60 | 10-60 | 7.1 | 2.9-52.9 |
| tocopherol) | | | | | | | |
| Vitamin B₁ (thiamin HCl) | mg | 100 | 0.12-1000 | 2-7 | 2-7 | 1.4 | 0.6-5.6 |
| Vitamin B₂ (riboflavin) | mg | 200 | 0.13-400 | 3-10 | 3-10 | 1.85 | 1.15-8.15 |
| Niacin (nicotinamide) | mg | 1500 | 1.6-3000 | 20-80 | 20-80 | 20.8 | 0-59.2 |
| Vitamin B₆ (pyridoxine HCl) | mg | 100 | 0.17-200 | 2-10 | 2-10 | 1.73 | 0.27-8.27 |
| Folate (folic acid) | mcg | 1000 | 40-5000 | 200-600 | 200-600 | 258 | 0-342 |
| Vitamin B₁₂ | mcg | 3000 | 0.24-2500 | 10-75 | 10-75 | 4.61 | 5.39-70.39 |
| (cyanocobalamin) | | | | | | | |
| Biotin | mcg | 2500 | 3-15000 | 40-100 | 40-100 | 50 | 0-50 |
| Pantothenic Acid (D-calcium | mg | 1000 | 0.5-200 | 5-20 | 5-20 | 4.0 | 1-16 |
| pantothenate) | | | | | | | |
| Calcium (calcium carbonate) | mg | 1500 | 130-2000 | 1000-2000 | 1000-2000 | 895 | 105-1105 |
| Iron (ferrous sulfate) | mg | 60 | 125-2000 | 20-100 | 20-60 | 13.2 | 6.8-46.8 |
| Iodine (potassium iodide) | mcg | 500 | 15-6000 | 50-250 | 50-250 | 200 | 0-50 |
| Magnesium (magnesium | mg | 400 | 42-1200 | 300-600 | 300-400 | 267 | 33-133 |
| citrate) | | | | | | | |
| Zinc (zinc oxide) | mg | 30 | 1.1-80 | 20-60 | 20-30 | 9.8 | 10.2-20.2 |
| Selenium (sodium selenate) | mcg | 200 | 5.5-200 | 100-250 | 100-200 | 93.6 | 6.4-106.4 |
| Manganese (manganse | mg | 10 | 0.23-30 | 1-3 | 1-3 | 2.7 | 0-0.3 |
| gluconate) | | | | | | | |
| Copper (cuprous gluconate) | mg | 9 | 0.09-8 | 1.5-3.0 | 1.5-3.0 | 1.2 | 0.3-1.8 |
| Chromium (chromium | mcg | 1000 | 3.5-1000 | 40-100 | 40-100 | 25.9 | 14.1-74.1 |
| bisglycinate chelate) | | | | | | | |
| Lutein (lutein, from | mg | 17.6 | 0.1-20 | 2-5 | 2-5 | 1.4 | 0.6-3.6 |
| Tagetes erecta, flower) | | | | | | | |

The formulator now formulates a safe and nutritionally effective multivitamin/mineral dietary supplement for adult U.S. women using the calculated ranges shown in Table 5. Formulators skilled in the art are familiar with the common practice of selecting the best types for each nutrient based on chemistry, stability, potency, purity and physical characteristics that are appropriate for the desired dosage form (e.g., tablet, hard-shell capsule, soft gelatin capsule, powder). For example, a formulator may choose to include in a supplement 700 mcg (mcg=micrograms) Vitamin A (retinol); 500 mg (mg=milligrams) Vitamin C (ascorbic acid); 90 mcg Vitamin D (cholecalciferol); 50 mg Vitamin E (RRR-alpha-tocopherol); 5 mg Vitamin B₁ (thiamin HCl); 5 mg Vitamin B₂ (riboflavin); 50 mg Niacin (nicotinamide); 5 mg Vitamin B₆ (pyridoxine HCl); 300 mcg Folate (folic acid); 50 mcg Vitamin B₁₂ (cyanocobalamin); 25 mcg Biotin; 5 mg Pantothenic Acid (D-calcium pantothenate); 500 mg Calcium (calcium carbonate); 10 mg Iron (ferrous sulfate); 25 mcg Iodine (potassium iodide); 40 mg Magnesium (magnesium citrate); 20 mg Zinc (zinc oxide); 10 mcg Selenium (sodium selenate); 0.2 mg Manganese (manganse gluconate); 1 mg Copper (cuprous gluconate); 50 mcg Chromium (chromium bisglycinate chelate); and 3 mg Lutein (lutein, from Tagetes erecta, flower).

### Embodiment 3

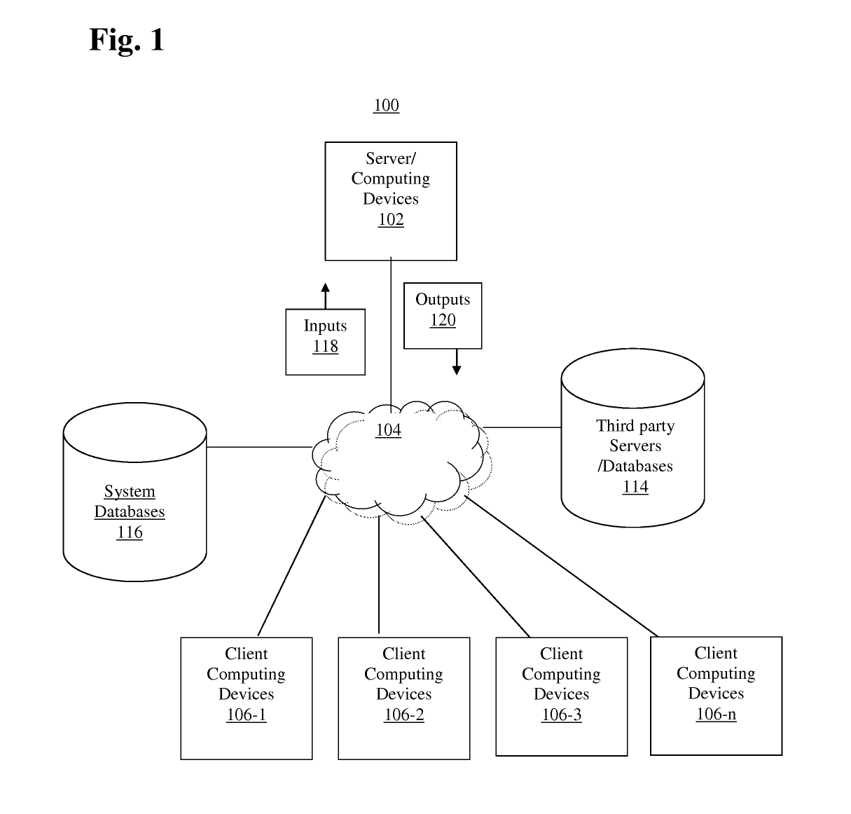

In this embodiment, the disclosed process is implemented through the use of a data processing device. FIG. 1 shows an exemplary system 100 for supplement development according to this embodiment. In this exemplary implementation, system 100 may include one or more servers/computing devices 102 (e.g., server 1, server 2, . . . , server n) operatively coupled over network 104 to one or more client computing devices 106-1 to 106-n, which may include one or more consumer computing devices, one or more provider computing devices, one or more remote access devices, etc. The one or more servers/computing devices 102 may also be operatively connected, such as over a network, to one or more third party servers/databases 114 (e.g., database 1, database 2, . . . , database n). The one or more servers/computing devices 102 may also be operatively connected, such as over a network, to one or more system databases 116 (e.g., database 1, database 2, . . . , database n). Various devices may be connected to the system, including, but not limited to, client computing devices, consumer computing devices, provider computing devices, remote access devices, etc. This system may receive inputs 118 and outputs 120 from the various computing devices, servers and databases.

Server/computing device 102 may represent, for example, any one or more of a server, a general-purpose computing device such as a server, a personal computer (PC), a laptop, a smart phone, a tablet, and/or so on. Networks 104 represent, for example, any combination of the Internet, local area network(s) such as an intranet, wide area network(s), cellular networks, WIFI networks, and/or so on. Such networking environments are commonplace in offices, enterprise-wide computer networks, etc. Client computing devices 106, which may include at least one processor, represent a set of arbitrary computing devices executing application(s) that respectively send data inputs to server/computing device 102 and/or receive data outputs from server/computing device 102. Such computing devices include, for example, one or more of desktop computers, laptops, mobile computing devices (e.g., tablets, smart phones, and human wearable devices), server computers, and/or so on. In this implementation, the input data comprises, for example, desired compounds, processing with server/computing device 102. In one implementation, the data outputs include, for example, reports, emails, templates, forms, and/or so on. Embodiments of the present disclosure may also be used for collaborative projects with multiple users logging in and performing various operations on a data project from various locations. Embodiments of the present disclosure may be web-based, smart phone-based and/or tablet-based.

In this exemplary implementation, server/computing device 102 includes at least one processor coupled to a system memory. System memory may include computer program modules and program data.

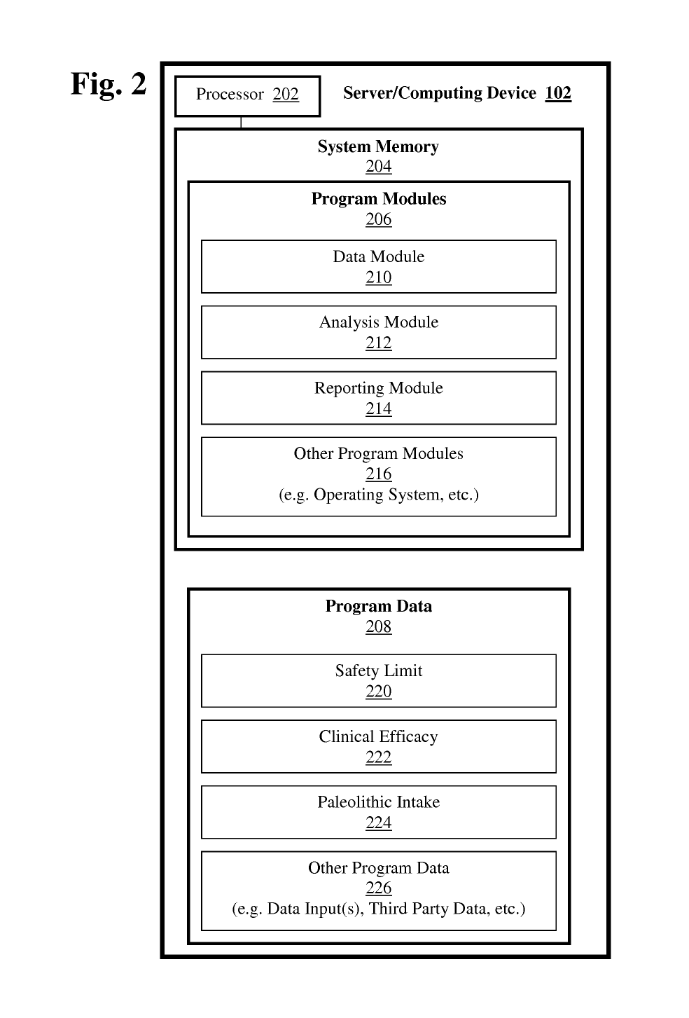

In this exemplary implementation, server/computing device 102 includes at least one processor 202 coupled to a system memory 204, as shown in FIG. 2. System memory 204 may include computer program modules 206 and program data 208. In this implementation program modules 206 may include data module 210, analysis module 212, reporting module 214, and other program modules 216 such as an operating system, device drivers, etc. Each program module 210 through 216 may include a respective set of computer-program instructions executable by processor(s) 202. This is one example of a set of program modules and other numbers and arrangements of program modules are contemplated as a function of the particular arbitrary design and/or architecture of server/computing device 102 and/or system 100 (FIG. 1). Additionally, although shown on a single server/computing device 102, the operations associated with respective computer-program instructions in the program modules 206 could be distributed across multiple computing devices. Program data 208 may include one or more of the datasets described above e.g., one or more of Safety Limits 220, Clinical Efficacy 222, Paleolithic Intake 224, and other program data 226 such as data input(s), third party data, competition assay data, and/or others.

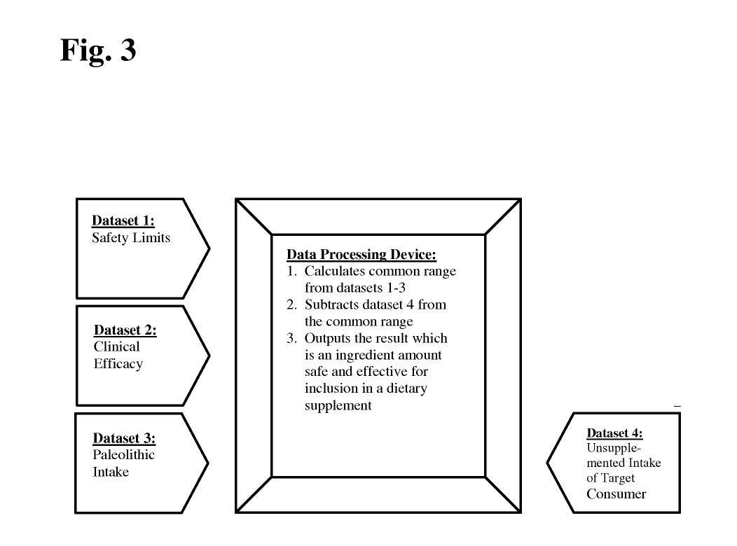

FIG. 3 is an overview of an exemplary process according to this embodiment of the disclosed process.

In view of the many possible embodiments to which the principles of the present disclosure may be applied, it should be recognized that the illustrated embodiments are only exemplary and should not be taken as limiting the scope of the invention. In addition, it should be recognized that the nutrients disclosed herein are only the most commonly used ingredients used to formulate dietary supplements, and that there are many other nutrients not listed specifically herein that also occur in foods today and throughout human evolution. For these other nutrients the same method as described in this disclosure can be applied to formulate safe and effective dietary supplements. The scope of the invention is defined by the following claims. I therefore claim as my invention all that comes within the scope and spirit of these claims.

I claim:

1. A method of formulating a dietary supplement comprising:
selecting an ingredient to include in the dietary supplement,
determining the safety limit amount for the ingredient;
determining the clinical efficacy range for the ingredient;
determining the Paleolithic intake amount range for the ingredient;
comparing the safety limit amount, clinical efficacy range, and Paleolithic intake amount range for the ingredient and determining a common range for the ingredient;
determining the target consumer for the dietary supplement;
determining the un-supplemented intake of the target consumer;
subtracting from the common range for the ingredient the un-supplemented intake of the ingredient of the target consumer to determine the safe and effective range for the dietary supplement;
incorporating into the dietary supplement an ingredient amount within the safe and effective range.

2. The method of claim 1 wherein determining the safety limit amount for the ingredient comprises consulting the ULs most currently listed for the ingredient by the Council for Responsible Nutrition.

3. The method of claim 1 wherein determining the safety limit amount for the ingredient comprises consulting the table below and determining the safety limit for the particular ingredient:

| Ingredient | Safety Limit | | Ingredient | Safety Limit | |
|---|---|---|---|---|---|
| Vitamin A (retinol and | 1,500 | mcg (w/high | Choline | 3,500 | mg |
| its esters) | | dietary retinol) | | | |
| Beta-Carotene | 25 | mg (non-smokers) | Vanadium | 1,800 | mcg |
| Vitamin D | 250 | mcg (10,000 IU) | Long-Chain n-3 Fatty | 3,000 | mg |
| | | | Acids (EPA + DHA) | | |
| Vitamin E | 1,000 | mg (1,600 IU) | Alpha-Linolenic Acid | 25 | g |
| Vitamin K | 10 | mg | Lutein | 17.6 | mg |
| Vitamin C | 2,000 | mg | Zeaxanthin | 10 | mg |
| Vitamin B₁ (thiamin) | 100 | mg | Lycopene | 11.3 | mg |
| Vitamin B₂ (riboflavin) | 200 | mg | Alpha-Carotene | 8.3 | mg |
| Nicotinic Acid | 250 | mg | Astaxanthin | 5.3 | mg |
| Nicotinamide | 1,500 | mg | Flavonols (quercetin, | 1,500 | mg |
| | | | etc.) | | |
| Vitamin B6 | 100 | mg | Flavan-3-ols (mono-, | 300 | mg |
| (pyridoxine) | | | oligo-, poly-meric) | | |
| Folic Acid | 1,000 | mcg | | | |
| Vitamin B₁₂ | 3,000 | mcg | | | |
| Biotin | 2,500 | mcg | | | |
| Pantothenic Acid | 1,000 | mg | | | |
| Calcium | 1,500 | mg | | | |
| Phosphorus | 1,500 | mg | | | |
| Magnesium | 400 | mg | | | |
| Potassium | 1,500 | mg | | | |
| Boron | 6 | mg | | | |
| Chromium | 1,000 | mcg | | | |
| Copper | 9 | mg | | | |
| Iodine | 500 | mcg | | | |
| Iron | 60 | mg | | | |
| Manganese | 10 | mg | | | |
| Molybdenum | 350 | mcg | | | |
| Selenium | 200 | mcg | | | |
| Zinc | 30 | mg | | | |

4. The method of claim 1 wherein determining the clinical efficacy range comprises consulting the table below and determining a clinical efficacy range for the particular ingredient:

| Ingredient | Clinical Efficacy Range | |
|---|---|---|
| Vitamin A (retinol and its esters) | 90-3,300 | mcg |
| Beta-Carotene | 1-180 | mg |
| Vitamin D | 2-250 | mcg |
| Vitamin E | 1.5-1,342 | mg |
| Vitamin K | 12-1,000 | mcg |
| Vitamin C | 9-10,000 | mg |
| Vitamin B₁ (thiamin) | 0.12-1,000 | mg |
| Vitamin B₂ (riboflavin) | 0.13-400 | mg |
| Nicotinic Acid | 1.6-3,000 | mg |
| Nicotinamide | 1.6-3,000 | mg |
| Vitamin B₆ (pyridoxine) | 0.17-200 | mg |
| Folic Acid | 40-5,000 | mcg |
| Vitamin B₁₂ | 0.24-2,500 | mcg |
| Biotin | 3-15,000 | mcg |
| Pantothenic Acid | 0.5-200 | mg |
| Calcium | 130-2,000 | mg |
| Phosphorus | 125-2,000 | mg |
| Magnesium | 42-1,200 | mg |
| Potassium | 470-5,000 | mg |
| Boron | 0.2-11.6 | mg |
| Chromium | 3.5-1,000 | mcg |
| Copper | 0.09-8 | mg |
| Iodine | 15-6,000 | mcg |
| Iron | 1.8-120 | mg |
| Manganese | 0.23-30 | mg |
| Molybdenum | 4.5-467 | mcg |
| Selenium | 5.5-200 | mcg |
| Zinc | 1.1-80 | mg |
| Choline | 55-6,000 | mg |
| Vanadium | 20-200,000 | mcg |
| Long-Chain n-3 Fatty Acids (EPA + DHA) | 50-4,000 | mg |
| Lutein | 0.1-20 | mg |
| Zeaxanthin | 0.01-10 | mg |
| Lycopene | 0.2-30 | mg |
| Alpha-Carotene | 0.01-5 | mg |
| Astaxanthin | 4-100 | mg |
| Flavonols (quercetin, etc.) | 10-1,000 | mg |
| Flavan-3-ols (mono-, oligo-, poly-meric) | 2.6-1,072 | mg |

5. The method of claim 1 wherein determining the Paleolithic intake amount range comprises consulting the table below and determining a Paleolithic intake amount range for the particular ingredient:

| Ingredient | Paleolithic Intake Range | |
|---|---|---|
| Vitamin A (retinol and its esters) | 1,000-4,000 | mcg |
| Beta-Carotene | 3-9 | mg |
| Vitamin D | 20-100 | mcg |
| Vitamin E | 10-60 | mg |
| Vitamin K | 75-300 | mcg |
| Vitamin C | 100-750 | mg |
| Vitamin B₁ (thiamin) | 2-7 | mg |
| Vitamin B₂ (riboflavin) | 3-10 | mg |
| Nicotinic Acid or Nicotinamide | 20-80 | mg |
| Vitamin B₆ (pyridoxine) | 2-10 | mg |
| Folic Acid | 200-600 | mcg |
| Vitamin B₁₂ | 10-75 | mcg |
| Biotin | 40-100 | mcg |
| Pantothenic Acid | 5-20 | mg |
| Calcium | 1,000-2,000 | mg |
| Phosphorus | 1,000-1,800 | mg |
| Magnesium | 300-600 | mg |
| Potassium | 3,000-7,000 | mg |
| Boron | 0.3-3 | mg |
| Chromium | 40-100 | mcg |
| Copper | 1.5-3 | mg |
| Iodine | 50-250 | mcg |
| Iron | 20-100 | mg |
| Manganese | 1-3 | mg |
| Molybdenum | 50-200 | mcg |
| Selenium | 100-250 | mcg |
| Zinc | 20-60 | mg |
| Choline | 300-800 | mg |
| Vanadium | 10-30 | mcg |
| Long-Chain n-3 Fatty Acids (EPA + DHA) | 500-1,500 | mg |
| Lutein | 2-5 | mg |
| Zeaxanthin | 0.2-1 | mg |
| Lycopene | 0.5-4 | mg |
| Alpha-Carotene | 0.25-3 | mg |
| Astaxanthin | 0-4 | mg |
| Flavonols (quercetin, etc.) | 20-100 | mg |
| Flavan-3-ols (mono-, oligo-, poly-meric) | 25-250 | mg |

6. The method of claim 1 wherein determining the target consumer for the dietary supplement comprises selecting a group of people having an age range and gender as the target consumer.

7. The method of claim 6 wherein determining the target consumer for the dietary supplement further comprises selecting a group of people having a further consistent characteristic from the group characteristics consisting of pregnant women, lactating women, athletes, individuals or patients with special dietary needs, individuals consuming a vegetarian diet, individuals consuming a vegan diet, and individuals consuming an omnivorous diet.

8. The method of claim 6 wherein determining un-supplemented intake of the target consumer comprises consulting Tables (4a-c) and determining the un-supplemented intake of the target consumer based on age and/or gender.

9. A method of formulating a dietary supplement comprising:
Selecting an ingredient to include in the dietary supplement,
Determining the clinical efficacy range for the ingredient;
Determining the Paleolithic intake amount range for the ingredient;
Comparing the clinical efficacy range and Paleolithic intake amount range for the ingredient and determining a common range for the ingredient;
Determining the target consumer for the dietary supplement;
Determining the un-supplemented intake of the target consumer;
Subtracting from the common range for the ingredient the un-supplemented intake of the ingredient of the target consumer to determine the safe and effective range for the dietary supplement;
Incorporating into the dietary supplement an ingredient amount within the safe and effective range.

10. The method of claim 9, wherein a micro-processing device is provided with the clinical efficacy range for the ingredient, the Paleolithic intake amount range for the ingredient, the target consumer for the dietary supplement, and the un-supplemented intake of the target consumer, and wherein the data processing device compares the clinical efficacy range and Paleolithic intake amount range for the ingredient to determine a common range for the ingredient, subtracts from the common range for the ingredient the un-supplemented intake of the ingredient of the target consumer, and reports as a result the safe and effective range for the dietary supplement for inclusion into a dietary supplement.

11. A method of formulating a dietary supplement comprising:
selecting an ingredient to include in the dietary supplement,
determining the clinical efficacy range for the ingredient;
determining the Paleolithic intake amount range for the ingredient;
comparing the clinical efficacy range, and Paleolithic intake amount range for the ingredient and determining a common range for the ingredient;
determining the target consumer for the dietary supplement;
determining the un-supplemented intake of the target consumer;
subtracting from the common range for the ingredient the un-supplemented intake of the ingredient of the target consumer to determine the safe and effective range for the dietary supplement;
incorporating into the dietary supplement an ingredient amount within the safe and effective range.
